(19) United States
(12) Patent Application Publication
(10) Pub. No.: US 2008/0087498 A1
(43) Pub. Date: Apr. 17, 2008

(54) Advanced "Omer" rescue system

(76) Inventor: Yoav Barzilai, Ashkelon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/757,397

(22) Filed: Jun. 4, 2007

Related U.S. Application Data
(62) Division of application No. 10/952,832, filed on Sep. 30, 2004.

(51) Int. Cl. A62B 1/20

(52) U.S. Cl. 182/193

(57) ABSTRACT

An escape system for moving a person on a cord on the exterior of a building. The building has a first surface and a second surface. The first surface and the second surface are substantially perpendicular to each other. The system comprises a control device for controlling the movement of the person on the cord and an anchoring device for reversibly mechanically attaching the control device to the building. The control device is substantially irreversibly mechanically connected to the anchoring device. The anchoring device has a first elongated element and a second elongated element. The first elongated is mechanically connected to the second elongated element. The first elongated element and the second elongated element are configured such that, the first elongated element at least partially rests against the first surface of the building and the second elongated element at least partially rests against the second surface of the building.

This application is a Divisional of U.S. patent application Ser. No. 10/952,832 filed Sep. 30, 2004, currently pending.

### FIELD AND BACKGROUND OF THE INVENTION

The present invention relates to rescue systems and, in particular, it concerns a professional rescue system for escape from a building with a cord for use by military and civil rescue and evacuation forces.

Of relevance to the present invention is U.S. Pat. No. 4,576,248 to Marom, which teaches a glider device for enabling a person to descend from a height in a controlled fashion. Reference is now made to FIGS. 1a and 1b, which show views of a glider device 35 of Marom. FIG. 1a is a plan view of glider device 35 with its cover removed that is constructed and operable in accordance with the prior art. FIG. 1b is an external plan view of glider device 35 of FIG. 1. Device 35 includes an elongated shallow housing 1, having a narrower top part 2 with an inlet 3 for a cable 22 and a wider bottom part 4 with an outlet 5 for cable 22. A substantially T-shaped lever 6 is pivotally attached at a point 7 within the bottom part 4 of housing 1. An opening 8 is provided in the wall of housing 1 for the leg of lever 6 to extend therethrough and be movable therein, the leg extending adjacent to top part 2. A web part 9 of lever 6 faces towards top part 2. Web part 9 is longer than the distance from pivot 7 to a corresponding sidewall 32 of housing 1. A web part 10 of lever 6 faces the outlet 5 and is shorter than web part 9. An abutment 11 for web part 10 extends integrally from sidewall 32 towards web part 10. In top part 2, three vertically aligned cylindrical guide bosses 12 are provided between inlet 3 and the bottom of top part 2. Guide bosses 12 as well as the walls facing them are undercut by rounded walls 13 for guiding cable 22 through top part 2 as well as providing a frictional braking force against the movement of cable 22. A tab 15, having an eyelet 16, is integrally formed with, and extends outwards from, the bottom of housing 1. Housing 1 is covered by a cover 30, which is a flat plate substantially of the same profile as housing 1. Cover 30 is pivotally attached to housing 1 at point 7. A spring-loaded pin 17 is mounted in an aperture in the wall of housing 1. Pin 17 engages in a hole 18 in cover 30, when cover 30 is closed. A pin 19 is disposed in a top corner of housing 1. Pin 19 is engaged by a notch 20 in cover 30, when cover 30 is closed. A plurality of slots 21 are provided in cover 30 in order to allow heat caused by friction between cable 22 and bosses 12 to dissipate. The inside walls of housing 1 as well as the walls of guide bosses 12 and webs 9, 10 are partially hollowed out with a radius corresponding to that of cable 22.

In operation, device 35 operates as follows. Device 35 is strapped to a person via eyelet 16. One end of cable 22 is anchored at the working height. Cover 30 is pivoted to expose guide bosses 12. Cable 22 is inserted into device 35 ensuring the anchored end of cable 22 is closest to inlet 3. Cable 22 is threaded around bosses 12, web 9 and abutment 11 and out through outlet 5 to the ground. Cover 30 is closed so as to be aligned with housing 1, thereby securing cable 22 in device 35. If the person falls from the height, or wants to lower himself to the ground, the weight of the person causes cable 22 to tighten. The tension in cable 22 causes lever 6 to rotate such that, web part 10 moves towards the abutment 11, thereby applying a braking force to cable 22 so that the person no longer moves. Therefore, the fall of the person is arrested. If the person holds the handle of lever 6 lightly towards housing part 2, the braking force on cable 22 by web 10 is released. A firm pull of lever 6 so that lever 6 is adjacent to top part 2 causes the cable to be wedged between web 9 and side-wall 32, thereby arresting movement of device 35. Alternatively, the person is lowered by holding lever 6 firmly against top part 2, thereby clamping cable 22 between web part 9 and sidewall 32. The person then slowly releases lever 6 in order to permit the movement of device 35 relative to cable 22. If lever 6 is released too much, sliding stops as the cable is clamped between web part 10 and abutment 11.

In another mode of operation, device 35 is attached at a certain height by means of tab 15 and eyelet 16. A person is attached to cable 22 by a harness (not shown). The person, who is attached to cable 22 can be slowly lowered to the ground by an operator-actuating lever 6.

A shortcoming of the aforementioned system is due to the diameter of a general purpose cable is restricted to 9 mm. If a cord wider than 9 mm is used with the above device, the person cannot descend using the glider device. This is because the combined friction between the wider cord and the frictional surfaces of the glider device prevent effective movement of the cord. In many circumstances, for example, but not limited to when it is necessary for two or more people to descend on the same cord at the same time or if the descent is being made by one person from a very high building, for example, from the third floor and up, a general purpose cord having a diameter of greater than 9 mm, typically 11 mm or 14 mm, is required.

Reference is now made to FIGS. 2 and 3. FIG. 2 is an isometric view of an anchoring device 50 that is constructed and operable in accordance with the prior art. FIG. 3 is a view of a person 52 escaping from a building 54 using anchoring device 50 of FIG. 2. Anchoring device 50 has an elongated element 62 and an elongated element 64. Elongated element 62 and elongated element 64 are mechanically connected in order to form an L-shaped anchoring device. Elongated element 62 rests on a horizontal surface of building 54 and elongated element 64 rests on a vertical surface of a first side of building 54. Elongated element 64 includes an anti-slip strip 66 to increase friction between elongated element 64 and building 54. A cable 68 is attached to elongated element 62. Person 52 can then descend on the second side of building 54 on cable 68. Anchoring device 50 is maintained in position solely due to friction between anchoring device 50 and the surfaces of building 54. Therefore, anchoring device 50 is very useful in emergency situations where there is little time for anchoring a cable to the building. For convenience, anchoring device 50 is configured to fold for storage and transportation.

Reference is now made to FIGS. 4 and 5. FIG. 4 is an isometric view of anchoring device 50 of FIG. 2 having a clamping attachment 56. FIG. 5 is a view of a person 58 escaping via a window 60 of building 54 using anchoring device 50 of FIG. 4. The horizontal surface of window 60 does not provide enough support for anchoring device 50 alone without clamping attachment 56, such that a cable 70 can be suspended from anchoring device 50 in order that person 58 can descend of cable 70. Therefore, clamping attachment 56 is used to improve the anchoring function of anchoring device 50 to window 60.

The abovementioned glider device and anchoring system are very useful for emergency escape situations. Nevertheless, these devices do not sufficiently address situations where, an injured escapee cannot operate these devices by himself, or where, due to time constraints, there is a need to evacuate more than one person at the same time. Additionally, the escape method of these devices may not be suitable or comfortable for many escapees.

There is therefore a need for an escape system for use in emergency situations for evacuating an injured person and/or more than one person at once. There is also a need for an escape system, which provides a comfortable means of escape.

### SUMMARY OF THE INVENTION

The present invention is a rescue system construction and method of operation thereof.

According to the teachings of the present invention there is provided, an escape system for moving a person on a cord on the exterior of a building, the building having a first surface and a second surface, the first surface and the second surface being substantially perpendicular to each other, the system comprising: (a) a control device for controlling the movement of the person on the cord; and (b) an anchoring device for reversibly mechanically attaching the control device to the building, the control device being substantially irreversibly mechanically connected to the anchoring device; the anchoring device having a first elongated element and a second elongated element, the first elongated being mechanically connected to the second elongated element, the first elongated element and the second elongated element being configured such that, the first elongated element at least partially rests against the first surface of the building and the second elongated element at least partially rests against the second surface of the building.

According to a further feature of the present invention, at least one of the first elongated element and the second elongated element has a anti-slip surface.

According to a further feature of the present invention, the anchoring device is configured to fold and lock.

According to a further feature of the present invention, the control device includes: (a) a housing having an internal volume, an inlet opening and an outlet opening, wherein: (i) the housing is configured such that, in operation the cord passes through the inlet opening, the internal volume and the outlet opening; and (ii) the internal volume has a friction arrangement configured for applying a braking force to the cord; and (b) a control lever mechanically connected to the housing, such that the control lever moves within the housing, wherein the control lever and the housing are configured, such that: (i) when the control lever is held in a first position, the cord moves relative to the housing, thereby allowing descent of the person; and (ii) when the position of the control lever is uncontrolled, the cord moves the control lever to a second position thereby applying a braking force to the cord.

According to a further feature of the present invention, the control device includes: (a) a pulley configured for at least partially circumscribing the cord thereon; and (b) a one-way locking arrangement configured for allowing the cord to be moved in one direction only around the pulley.

According to the teachings of the present invention there is also provided, an anchoring system for anchoring a cord to a frame of a door or a window of a building, the frame including a plurality of elongated frame elements, the cord having a load thereon, the anchoring system comprising: (a) an elongated element having a first end and a second end, the elongated element being extendable; and (b) two gripping members, one of the gripping members being mechanically connected to the first end, another of the gripping members being mechanically connected to the second end, wherein the elongated element has an extension mechanism for applying an extension force to the elongated element so as to force the gripping members substantially against the frame, the gripping members being configured, such that, the gripping members substantially grip the frame thereby preventing the anchoring system from being pulled out of the frame by the load on the cord.

According to a further feature of the present invention, at least one of the elongated element and the gripping members has an attachment region for attachment of the cord to the attachment region.

According to a further feature of the present invention, extension mechanism includes a screw thread arrangement for adjusting the length of the elongated element.

According to a further feature of the present invention, one of the gripping members is configured to extend around one of the elongated frame elements.

According to the teachings of the present invention there is also provided, an anchoring system for anchoring a cord to a frame of a window or a door of a building, the frame including a header element, the building including an wall, the cord having a load thereon, the anchoring system comprising: (a) a first anchoring device having a first elongated element and a second elongated element, the first anchoring device having an attachment region for attachment of the cord to the attachment region, the first elongated element being mechanically connected to the second elongated element, the first elongated element and the second elongated element being configured, such that: (i) the first elongated element at least partially rests against the header element of the frame; and (ii) the second elongated element at least partially rests against the wall of the building; and (b) a securing pole for securing the first anchoring device adjacent to the header element of the frame, the securing pole including: (i) an elongated extendable element having a first end and a second end; and (ii) a first gripping member mechanically connected to the first end; and (iii) an extension mechanism for applying an extension force on the elongated extendable element so as to secure the first anchoring device between the first gripping member and the header element of the frame, the securing pole being configured, such that, the gripping members grip the first anchoring device, thereby preventing the first anchoring device from being pulled off of the frame by the load on the cord.

According to a further feature of the present invention, the first anchoring device is configured to fold and lock.

According to a further feature of the present invention, there is also provided a second anchoring device configured such that, at least part of the second anchoring device rests against the internal wall of the building and at least part of the anchoring device rests against the frame, the securing pole including a second gripping member mechanically connected to the second end, the securing pole being configured to secure the second anchoring device between the second gripping member and the frame.

According to the teachings of the present invention there is also provided, a glider device for controlling the descent of a person on a cord, the device comprising: (a) a housing having an internal volume, an inlet opening and an outlet opening, wherein: (i) the housing is configured such that in operation the cord passes through the inlet opening, the internal volume and the outlet opening; and (ii) the internal volume has a friction arrangement configured for applying a braking force to the cord, the friction arrangement including a plurality of substantially oval cross-section projections configured for winding the cord at least partially around each of the projections; and (b) a control lever mechanically connected to the housing, such that the control lever moves within the housing, wherein the control lever and the housing are configured, such that: (i) when the control lever is held in a first position, the cord moves relative to the housing, thereby allowing descent of the person on the cord; and (ii) when the position of the control lever is uncontrolled, the cord moves the control lever to a second position thereby applying a braking force to the cord.

According to the teachings of the present invention there is also provided, a glider device for controlling the descent of a person on a cord, the device comprising: (a) a housing having an internal volume, an inlet opening and an outlet opening, wherein: (i) the housing is configured such that, in operation the cord passes through the inlet opening, the internal volume and the outlet opening; and (ii) the internal volume has a friction arrangement configured for applying a braking force to the cord, the friction arrangement including a sinuous path between two sinuous walls, the sinuous path having a substantially constant width; and (b) a control lever mechanically connected to the housing, such that the control lever moves within the housing, wherein the control lever and the housing are configured, such that: (i) when the control lever is held in a first position, the cord moves relative to the housing, thereby allowing descent of the person on the cord; and (ii) when the position of the control lever is uncontrolled, the cord moves the control lever to a second position thereby applying a braking force to the cord.

According to the teachings of the present invention there is also provided, a glider device for simultaneously controlling the descent of a first person and a second person on a cord, the device comprising: (a) a housing having an internal volume, an inlet opening and an outlet opening, wherein: (i) the housing is configured such that, in operation the cord passes through the inlet opening, the internal volume and the outlet opening; and (ii) the internal volume has a friction arrangement configured for applying a braking force to the cord; (b) a control lever mechanically connected to the housing, such that the control lever moves within the housing, wherein the control lever and the housing are configured, such that: (i) when the control lever is held in a first position, the cord moves relative to the housing, thereby allowing descent of the person; and (ii) when the position of the control lever is uncontrolled, the cord moves the control lever to a second position thereby applying a braking force to the cord; and (c) a first eyelet and a second eyelet, the first eyelet and the second eyelet being mechanically connected to the housing, the first eyelet and the second eyelet being configured for attaching the first person and the second person, respectively, to the glider.

According to the teachings of the present invention there is also provided, a glider device for controlling the descent of two people on a plurality of cords, the device comprising a first section and a second section, the first section being mechanically connected to the second section, each of the first section and the second section having: (a) a housing having an internal volume, an inlet opening and an outlet opening, the housing being configured such that, in operation one of the cords passes through the inlet opening, the internal volume and the outlet opening, the internal volume having a friction arrangement configured for applying a braking force to the one cord; and (b) a control lever mechanically connected to the housing, such that the control lever moves within the housing, the control lever and the housing being configured, such that tension of the one cord moves the control lever to a first position, when the control lever is uncontrolled, thereby applying a braking force to the one cord, wherein the glider device is configured, such that, when the control lever of the first section and the control lever of the second section are held in a second position, the first cord and the second cord move relative to the glider device, thereby allowing descent of the people.

According to the teachings of the present invention there is also provided, a glider device for simultaneously controlling the descent of a person on a first cord and a second cord, the device comprising: (a) a housing having an internal volume, an inlet opening and an outlet opening, wherein: (i) the housing is configured such that, in operation the first cord passes through the inlet opening, the internal volume and the outlet opening; and (ii) the internal volume has a friction arrangement configured for applying a braking force to the first cord; (b) a control lever mechanically connected to the housing, such that the control lever moves within the housing, wherein the control lever and the housing are configured, such that: (i) when the control lever is held in a first position, the first cord passes moves relative to the housing thereby allowing descent of the person; and (ii) when the position of the control lever is uncontrolled, the first cord moves the control lever to a second position thereby applying a braking force to the first cord; and (c) a fail-safe arrangement mechanically connected to the housing, the fail-safe arrangement being configured for controlling relative movement of the second cord and the fail-safe arrangement, such that, when the second cord moves in relation to the fail-safe arrangement greater than a minimum speed, the fail-safe arrangement at least slows relative movement of the second cord and the fail-safe device.

According to a further feature of the present invention, the fail-safe arrangement is configured, such that, when the second cord moves in relation to the fail-safe arrangement greater than a minimum speed, the fail-safe arrangement stops the relative movement of the second cord and the fail-safe arrangement.

According to the teachings of the present invention there is also provided, a method for controlling the movement of a cord having a load thereon, the method comprising the steps of: (a) providing a first controller arrangement configured to apply a braking force as a function of the speed of movement of the cord; and (b) winding the cord around a second controller arrangement according to the magnitude of the load, such that a braking force applied to the cord by the second controller arrangement is a function of an amount of the winding.

According to a further feature of the present invention, the step of providing is performed by providing a pulley and an expandable braking arrangement for the first controller arrangement, the cord at least partially circumscribing the pulley, the first controller arrangement being configured such that, as the speed of the cord increases, the expandable braking arrangement expands thereby applying a braking force for slowing down the pulley.

According to a further feature of the present invention, the first controller arrangement is configured to limit the speed of movement of the cord to a first speed.

According to the teachings of the present invention there is also provided, an escape system for lowering a person on a cord, comprising: (a) a first controller arrangement configured to apply a braking force as a function of the speed of movement of the cord; and (b) a second controller arrangement configured for manually winding the cord around the second controller arrangement according to the magnitude of the person, such that a braking force applied to the cord by the second controller arrangement is a function of an amount of the winding.

According to a further feature of the present invention, there is also provided an anchoring device for reversibly mechanically attaching the first controller arrangement to the building, the first controller arrangement being mechanically connected to the anchoring device.

According to a further feature of the present invention, the first controller arrangement includes a pulley and an expandable braking arrangement, the pulley being configured such that, the cord at least partially circumscribes the pulley, the first controller arrangement being configured such that, as the speed of the cord increases, the expandable braking arrangement expands thereby applying a braking force for slowing down the pulley.

According to a further feature of the present invention, the first controller arrangement is configured to limit the speed of movement of the cord to a first speed.

According to a further feature of the present invention, the second controller arrangement includes an elongated element for winding the cord around.

According to a further feature of the present invention, the second controller arrangement is a static device.

According to the teachings of the present invention there is also provided, an escape system for forcing an entry into a target region of a building, the system comprising: (a) an explosive charge configured for forcing the entry into the target region; (b) an elongated member having a first end and a second end, the explosive charge being mechanically connected to the first end; and (c) an anchoring device mechanically connected to the second end, the anchoring device being configured for securing the elongated member to the building, wherein at least one of the anchoring device and the elongated member are configured such that: (i) the elongated member is extensible; and the elongated member rotates, in at least one degree of freedom, with respect to the anchoring device, in order to position the explosive charge adjacent to the target region.

### BRIEF DESCRIPTION OF THE DRAWINGS

The invention is herein described, by way of example only, with reference to the accompanying drawings, wherein:

FIG. 1a is a plan view of a glider device with its cover removed that is constructed and operable in accordance with the prior art;

FIG. 1b is an external plan view of the glider device of FIG. 1;

FIG. 2 is an isometric view of an anchoring device that is constructed and operable in accordance with the prior art;

FIG. 3 is a view of a person escaping from a building using the anchoring device of FIG. 2;

FIG. 4 is an isometric view of the anchoring device of FIG. 2 having a clamping attachment;

FIG. 5 is a view of a person escaping from a building using the anchoring device of FIG. 4;

FIG. 6a is an escape system that is constructed and operable in accordance with a preferred embodiment of the present invention;

FIG. 6b is an isometric view of the lockable joint of the escape system of FIG. 6a in a locked position;

FIG. 6c is an isometric view of the lockable joint of the escape system of FIG. 6a in an unlocked and folded position;

FIG. 7 is a schematic side view of an escape system that is constructed and operable in accordance with a first alternate embodiment of the present invention;

FIG. 8a is a front view of an escape system that is constructed and operable in accordance with a second alternate embodiment of the invention;

FIG. 8b is cross-sectional view of the escape system of FIG. 8a through line A-A of FIG. 8a;

FIG. 9 is side view of an escape system that is constructed and operable in accordance with a third alternate embodiment of the invention;

FIG. 10 is a plan view of a first glider device with its cover removed for use with the escape system of FIG. 8a;

FIG. 11 is a plan view of a second glider device with its cover removed for use with the escape system of FIG. 8a;

FIG. 12 is a plan view of a glider device having two eyelets for use with the escape system of FIG. 8a;

FIG. 13 is a plan view of a double glider device for use with the escape system of FIG. 8a;

FIG. 14a is a schematic plan view of a glider device having a fail-safe arrangement, the fail-safe arrangement having its cover removed, for use with the escape system of FIG. 8a;

FIG. 14b is a schematic view illustrating the operation of the fail-safe arrangement of FIG. 14a;

FIG. 15a is front view of an escape system that is constructed and operable in accordance with a fourth alternate embodiment of the invention;

FIG. 15b is an exploded view of a centrifugal speed control system of the escape system of FIG. 15a; and

FIG. 16 is an isometric view of an escape system that is constructed and operable in accordance with a fifth alternate embodiment of the invention.

### DESCRIPTION OF THE PREFERRED EMBODIMENTS

The present invention is a rescue system construction and method of operation thereof.

The principles and operation of a rescue system according to the present invention may be better understood with reference to the drawings and the accompanying description.

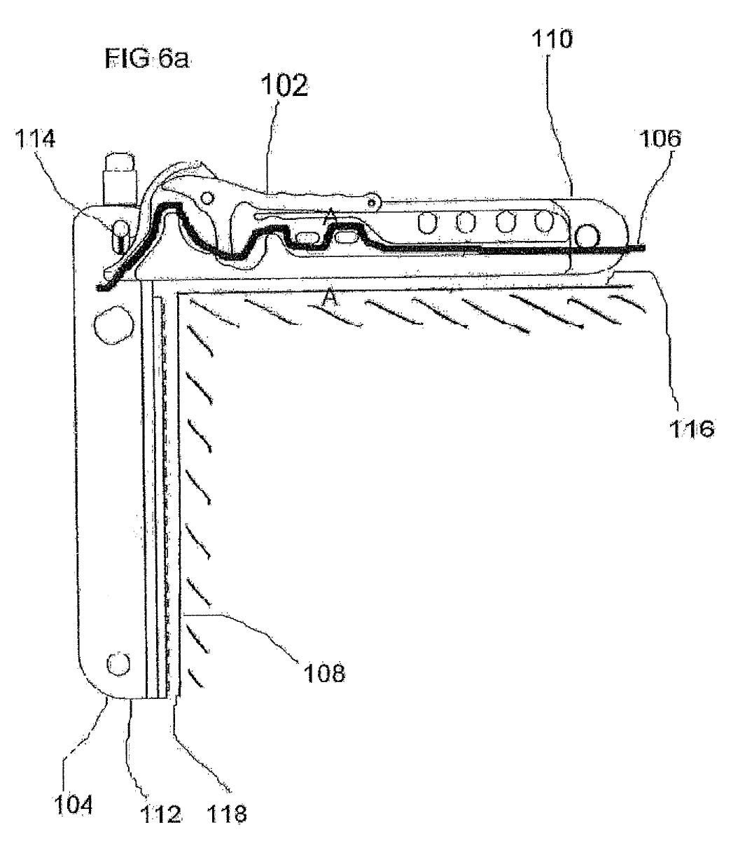

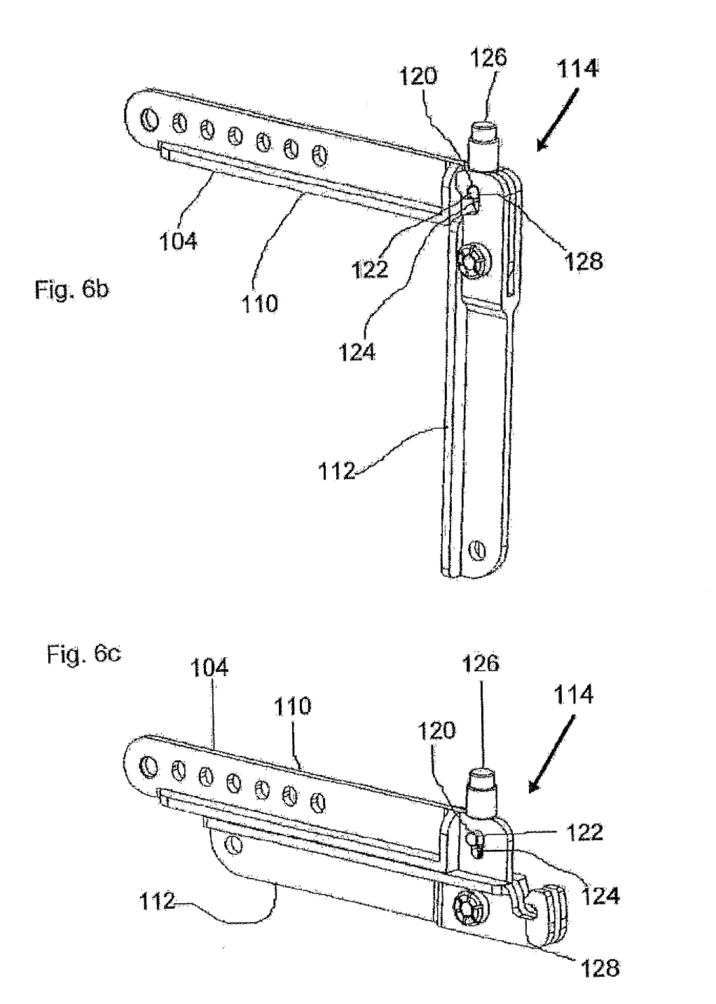

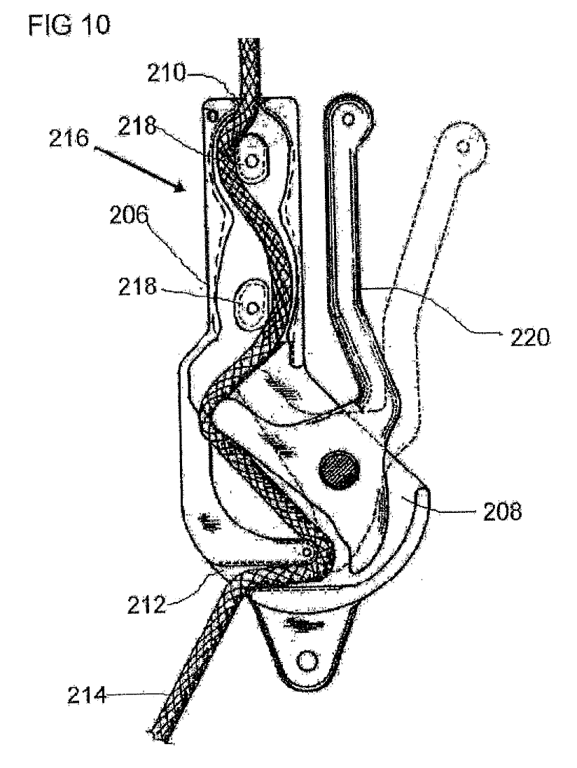

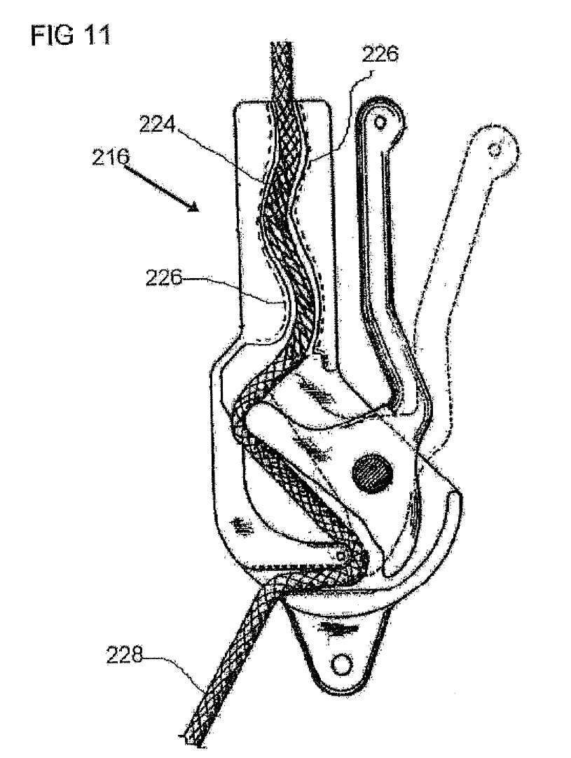

Reference is now made to FIGS. 6a, which is an escape system 100 that is constructed and operable in accordance with a preferred embodiment of the present invention. Escape system 100 includes a control device 102 and an anchoring device 104. Control device 102 is configured for controlling the movement of a person (not shown) on a cord 106. The term “cord” is defined herein to include a line made of twisted fibers or threads, rope, cable, chain or any other equivalent elongated means for lowering and raising loads. Cord 106 is typically a cord having international standards certification, made from nylon or Kevlar or a cord having a steel core with a textile coating. Anchoring device 104 is configured for reversibly mechanically attaching control device 102 to a building 108. The term “reversibly mechanically attaching” is defined herein to exclude welding, screwing, bolting or otherwise permanently mechanically connecting anchoring device 104 to building 108. Reversibly mechanically attaching includes, but is not limited to, attaching anchoring device 104 to building 108 using friction and clamping. Control device 102 is substantially irreversibly mechanically connected to anchoring device 104. The term “substantially irreversibly mechanically connected” is defined herein to exclude connection by a convenient arrangement not requiring tools such as a quick release mechanism or by tying. Control device 102 and anchoring device 104 are typically connected by bolting, welding or riveting, or by integrally forming control device 102 with anchoring device 104. Anchoring device 104 has an elongated element 110 and an elongated element 112. Elongated element 110 is mechanically connected to elongated element 112 by a lockable joint 114 so that anchoring device 104 can fold for storage and transportation as well as form an L-shape anchoring device in use, as will be described in more detail with reference to FIGS. 6b and 6c. Elongated element 110 and elongated element 112 are configured such that, elongated element 110 rests against a horizontal surface 116 of building 108 and elongated element 112 rests against a vertical surface 118 of building 108. Horizontal surface 116 and vertical surface 118 are substantially perpendicular. The term “substantially perpendicular” is defined, herein, to include not exactly perpendicular surfaces, as long as the surfaces are still suitable for resting elongated element 110 and elongated element 112 thereon so that anchoring device 104 can perform an anchoring function for control device 102. Elongated element 112 includes an anti-slip surface for increasing friction between elongated element 112 and vertical surface 118. Control device 102 is typically a glider device, for example, but not limited to the glider devices described with reference to FIGS. 10 and 11 or any other glider device. In operation, cord 106 is inserted into control device 102. An escapee is attached to cord 106. Anchoring device 104 is anchored to building 108 by either resting anchoring device 104 on the corner of the roof or by clamping anchoring device 104 to a window using a clamping device similar to clamping attachment 56 (FIGS. 4 and 5). The escapee is lowered down by an operator (not shown) operating control device 102.

Reference is now made to FIGS. 6b to 6c. FIG. 6b is an isometric view of lockable joint 114 of escape system 100 of FIG. 6a in a locked position (without control device 102 for clarity). FIG. 6c is an isometric view of lockable joint 114 of escape system 100 of FIG. 6a in an unlocked and folded position. As described above anchoring device 104 is configured to fold for transportation and storage purposes. Additionally, anchoring device 104 is configured to lock in an L-shape for anchoring to a building. Lockable joint 114 includes a spring-loaded pin arrangement 120 mechanically connected to elongated element 110. Spring-loaded pin arrangement 120 has a pin 122 and a spring 124. Pin 122 engages into a notch 128 at the end of elongated element 112, when elongated element 110 and elongated element 112 form the L-shape. Spring 124 pushes pin 122 into notch 128 thereby locking rotational movement of elongated element 110 with elongated element 112. Lockable joint 114 includes a button 126 mechanically connected to spring loaded pin arrangement 120. Handle 126 enables an operator of anchoring device 104 to release pin 122 from notch 128 in order unlock lockable joint 114 and thereby enable folding of anchoring device 104.

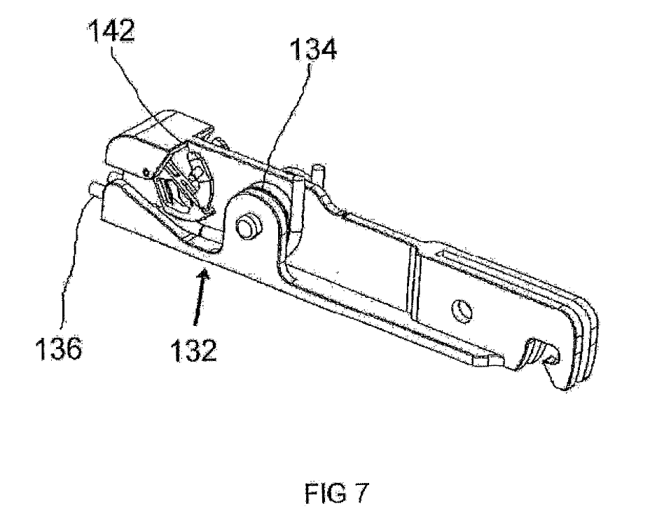

Reference is now made to FIG. 7, which is a schematic side view of an escape system 130 that is constructed and operable in accordance with a first alternate embodiment of the present invention. Escape system 130 is the same as escape system 100 except that control device 102 is replaced by a control device 132. Control device 132 is configured for raising a person attached to a cord 136 from a lower storey of a building to a roof of the building, for example, but not limited to, for removing people to safety from the roof by a helicopter when access to the roof from the lower storey is otherwise blocked. Control device 132 includes a pulley 134 configured for at least partially circumscribing cord 136 thereon. Control device 132 also includes a one-way locking arrangement 142 configured for allowing cord 136 to be moved in one direction only around pulley 134 and not in two directions around pulley 134. Escape system 130 includes two control devices 132 on either side of escape system 130.

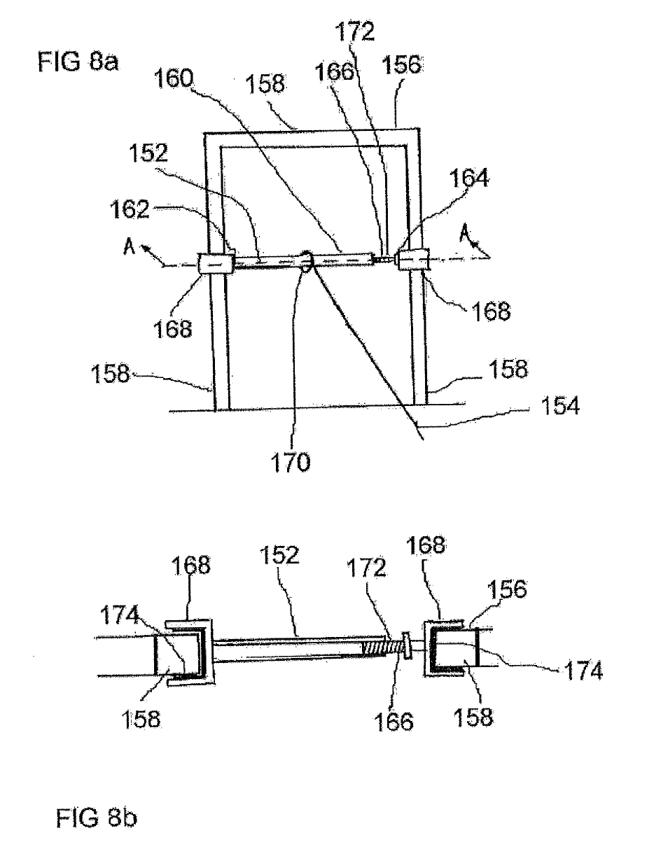

Reference is now made to FIGS. 8a and 8b. FIG. 8a is a front view of an escape system 150 that is constructed and operable in accordance with a second alternate embodiment of the invention. FIG. 8b is cross-sectional view of escape system 150 of FIG. 8a through line A-A of FIG. 8a. Escape system 150 includes a cord 154 and an anchoring system 152 for anchoring cord 154 to a frame 156 of a door or a window of a building. Frame 156 includes a plurality of elongated frame elements 158. Cord 154 is configured for having a load thereon, for example a person lowering himself by means of cord 154.

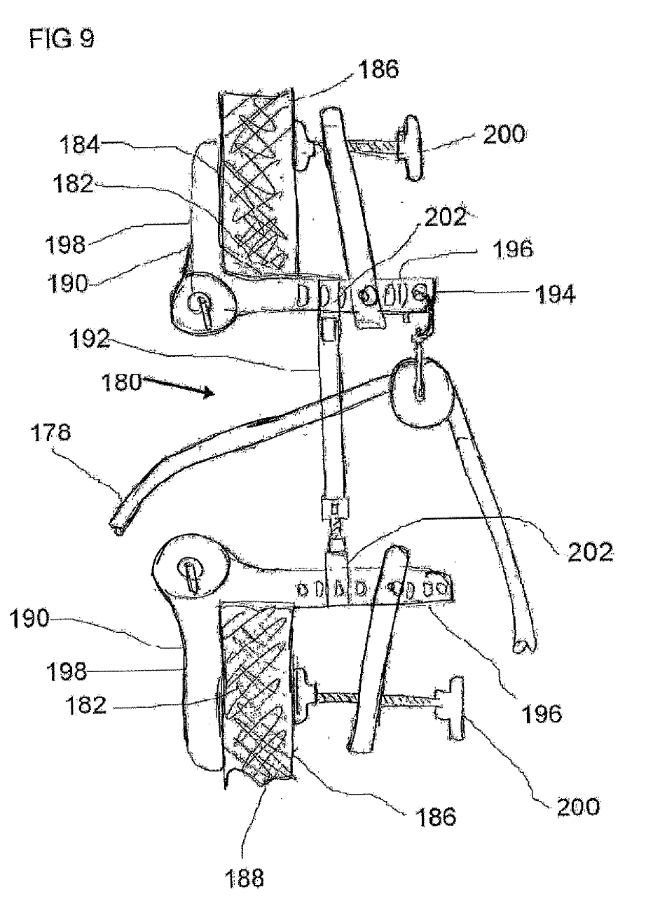

Anchoring system 152 includes an elongated element 160 having an end 162 and an end 164. Elongated element 160 is extendible. Anchoring system 152 includes two gripping members 168. One gripping member 168 is mechanically connected to end 162. Another gripping member 168 is mechanically connected to end 164. Each gripping member 168 is configured to extend around one elongated frame element 158. The term “around” is defined herein as, gripping member 168 extends adjacent to at least two sides, preferably three sides, of elongated frame elements 158 (FIG. 8b). Elongated element 160 and/or gripping members 168 have an attachment region 170 for attachment of cord 154 to attachment region 170. Attachment of cord 154 to attachment region 170 is performed for example, but not limited to, tying cord 154 around anchoring system 152, feeding cord 154 though a hole in elongated element 160 or using a mechanical coupling. Elongated element 160 includes an extension mechanism 172 disposed towards end 164 of elongated element 160. Extension mechanism 172 is configured for adjusting the length of elongated element 160. Additionally, extension mechanism 172 is configured for applying an extension force to elongated element 160 so as to force the gripping members substantially against frame 156. The term “substantially against” is defined herein to include securing another element against the frame between gripping member 168 and frame 156, for example, but not limited to the embodiment described with reference to FIG. 9. Extension mechanism 172 typically includes a screw thread arrangement 166 disposed between two sections of elongated element 160 for adjusting the length of elongated element 160 and applying the extension force to elongated element 160. Gripping members 168 are configured, such that, gripping members 168 substantially grip frame 156 thereby preventing anchoring system 152 from being pulled out of frame 156 by the load on cord 154. Therefore, gripping members 168 include non-slip surfaces 174, for example, but not limited to rubberized surfaces or a plurality of ridge. The term “substantially grip” is defined herein to include gripping another element which is secured against the frame between gripping member 168 and frame 156, for example, but not limited to the embodiment described with reference to FIG. 9.

Reference is now made to FIG. 9, which is a side view of an escape system 176 that is constructed and operable in accordance with a third alternate embodiment of the invention. Escape system 176 includes a cord 178 and an anchoring system 180 for anchoring cord 178 to a frame 182 of a window or a door of a building 188. Frame 182 includes a header element 184. The building has a wall 186. Cord 178 is configured for having a load thereon. Anchoring system 180 includes two L-shape anchoring devices 190 and a securing pole 192 for securing anchoring devices 190 against frame 182. One anchoring device 190 is secured against header element 184 and the other anchoring device 190 is secured at the base of frame 182. Anchoring devices 190 which is secured against header element 184 has an attachment region 194 for attachment of cord 178 to attachment region 194. Therefore, a person escaping from building 188 through frame 182 is lowered gently from the top of frame 182. This method has a clear advantage over prior art methods where the escapee first climbs out of the building and is then suspended outside of the building, below the frame, before controlled lowering begin (FIG. 5).

Each anchoring device 190 includes an elongated element 196 and an elongated element 198 and a clamping device 200. Anchoring devices 190 is the same as anchoring device 50 with clamping attachment 56 (FIG. 4). Elongated element 196 and elongated element 198 are mechanically connected to each other. Elongated element 196 and elongated element 198 are configured such that elongated element 196 rests against frame 182 and elongated element 198 rests against wall 186.

Securing pole 192 is the same as anchoring system 152 (FIG. 5a). Securing pole 192 is positioned substantially vertically in frame 182. Securing pole 192 is extended in order to secure anchoring devices 190 between gripping members 202 of securing pole 192 and frame 182, thereby preventing anchoring devices 190 from being pulled off of frame 182 by the load on cord 178. The term “substantially vertically” includes orientations, which are not completely vertical, but are vertical enough so that securing pole 192 secures anchoring devices 190 against frame 182.

Reference is now made to FIG. 10, which is a plan view of a first glider device 204 with its cover removed for use with escape system 150 of FIG. 8a. It will be appreciated by those ordinarily skilled in the art that glider device 204 can be used with the other embodiments described herein or any other suitable escape system. By way of introduction, glider device 204 is typically used for controlling the descent of a person on a cord. The term “on a cord” is not restricted to a person being attached to a cord whereby the cord is lowered in order to lower the person. The term “on a cord” also includes a person who is attached to the glider device, which glides on the cord. Glider device 204 uses a cord 214 having a diameter greater than 11 mm, which enables glider device 204 to support higher loads and/or descending from greater heights than prior art glider devices. This aspect will be explained in more detail below.

Glider device 204 includes a housing 206 having an internal volume 208, an inlet opening 210 and an outlet opening 212. Housing 206 is configured such that, in operation cord 214 passes through inlet opening 210, internal volume 208 and outlet opening 212. Internal volume 208 has a friction arrangement 216 configured for applying a braking force to cord 214. The term “applying a braking force to the cord” is defined, herein, as increasing friction between the cord and another surface thereby slowing or stopping relative movement of the cord and the glider device. Friction arrangement 216 includes two substantially oval cross-section projections 218 configured for winding cord 214 at least partially around each of projections 218. The term “substantially oval” is defined herein to exclude circular. Prior art glider-devices have included circular projections, which prevent heavy-duty cords from being used, as the circular projections bend these cords too much. Glider device 204 also includes a control lever 220 mechanically connected to housing 206, such that control lever 220 moves within housing 206. Control lever 220 and housing 206 are configured, such that: (i) when control lever 220 is held in one position, cord 214 moves relative to housing 206, thereby allowing descent of a person on cord 214; and (ii) when control lever 220 is not held by the person operating glider device 204, the position of control lever 220 is uncontrolled and tension in cord 214 moves control lever 220 to another position, thereby applying a braking force to cord 214. The “braking force” applied to cord 214 by glider device 204 arrests the relative motion between cord 214 and glider device 204.

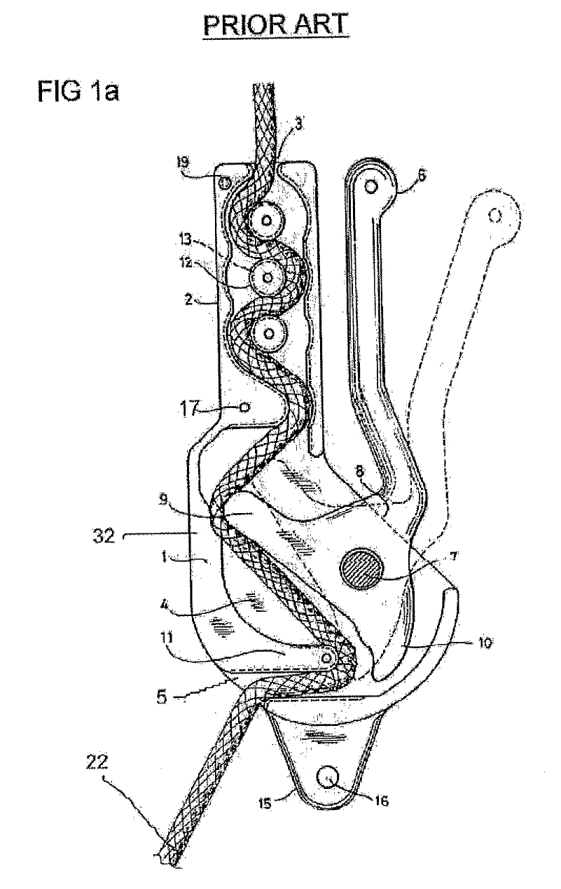

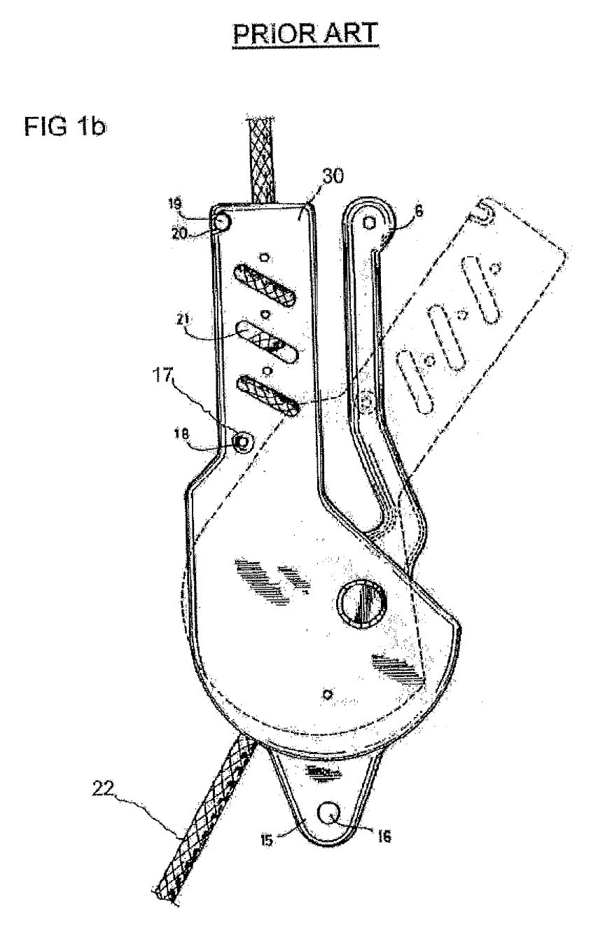

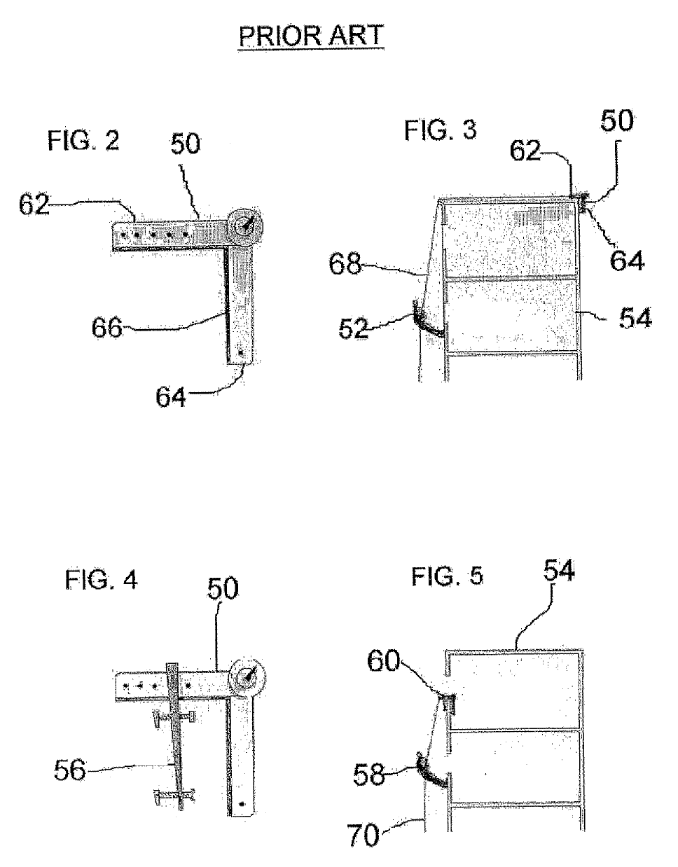

Reference is now made to FIG. 1, which is a plan view of a second glider device 222 with its cover removed for use with escape system 150 of FIG. 8a. It will be appreciated by those ordinarily skilled in the art that glider device 222 can be used with the other embodiments described herein or any other suitable escape system. Glider device 222 is used with a more heavy-duty cord 228 than cord 214 of glider device 204. Glider device 222 is typically used with a 14 mm cord in order to enable escape from very high building or escape by two people at once via glider device 222. Glider device 222 obviously has to have wider channels to accept a wider cord 228. Nevertheless, glider device 222 is substantially the same as glider device 204, except that friction arrangement 216 of glider device 222 does not include any centrally disposed projections around which cord 228 is wound. Friction arrangement 216 of glider device 222 includes a sinuous path 224 between two sinuous walls 226. Sinuous path 224 has a substantially constant width. The term “width” is defined herein as the length of an imaginary line extending between walls 226, the line being perpendicular to the axis of cord 228 at the intersection of the line and the axis. The term “substantially constant width” is defined herein as, sinuous path 224 having a width between 1 to 1.5 times the diameter of cord 228. The width of sinuous path 224 is preferably between 1 to 1.05 times the diameter of cord 228. The term “substantially constant” is defined herein to include a number of gaps in walls 226, where the gaps do not affect the efficient functioning of friction arrangement 216.

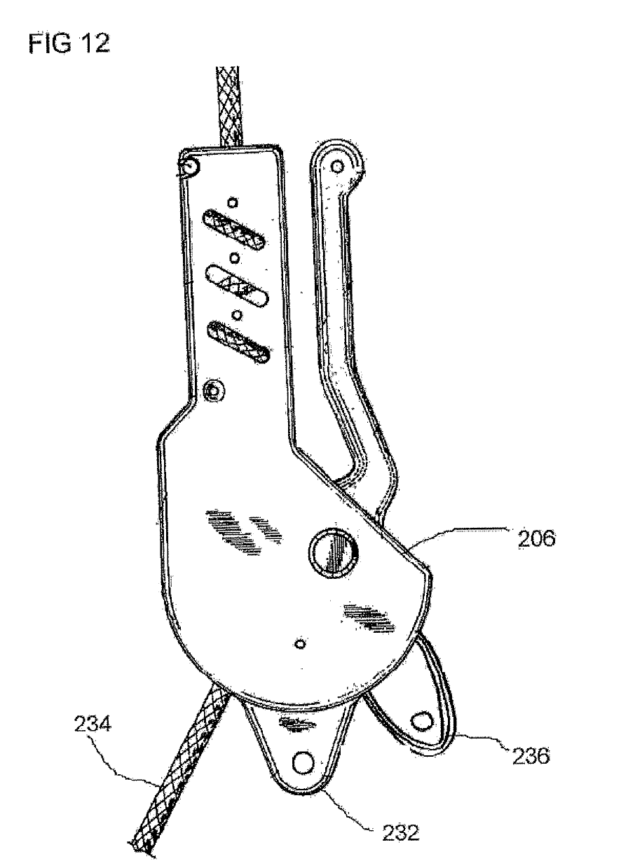

Reference is now made to FIG. 12, which is a plan view of a glider device 230 having two eyelet 232, 236 for use with escape system 150 of FIG. 8a. It will be appreciated by those ordinarily skilled in the art that glider device 230 can be used with the other embodiments described herein or any other suitable escape system. Glider device 230 is configured for simultaneously controlling the descent of a first person and a second person on a single cord 234. This is especially useful for evacuating injured people or for evacuating two people at once using the same rope and same glider device. Glider device 230 is substantially the same as glider device 222 or glider device 204 with the addition of another eyelet 236. Eyelet 232 and eyelet 236 are mechanically connected to housing 206 of glider device 230. Eyelet 232 and eyelet 236 are configured for attaching one person and another person, respectively, to glider device 230.

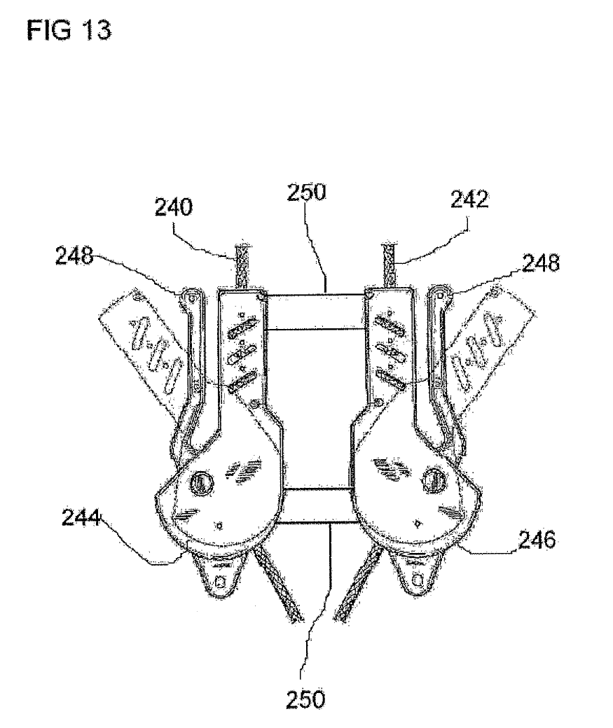

Reference is now made to FIG. 13, which is a plan view of a double glider device 238 for use with escape system 150 of FIG. 5a. It will be appreciated by those ordinarily skilled in the art that glider device 238 can be used with the other embodiments described herein or any other suitable escape system. Double glider device 238 is a glider device for controlling the descent of two people on two cords 240, 242, Double glider device 238 includes a section 244 and a section 246. Cord 240 is associated with section 244 and cord 242 is associated with section 246. Each section 244, 246 is substantially the same as glider device 204 or glider device 222 or glider device 230 or a suitable prior art glider-device. Section 244 and section 246 are typically mechanically connected together using connecting elements 250 using bolting, riveting or welding. The term “mechanically connected” is defined to include forming section 244 and section 246 as an integrally formed unit. Each section 244, 246 has a control lever 248 for controlling the relative motion between cords 240, 242 and double glider device 238. Double glider device 238 operates as follows. If both control levers 248 are held in a first position, then there is relative movement between cords 240, 242 and double glider device 238, thereby allowing descent of the people. If any one of control levers 248 becomes uncontrolled then relative movement between cords 240, 242 and double glider device 238 is arrested. For example, if control lever 248 of section 244 becomes uncontrolled, then tension of cord 240 moves control lever 248 to a second position, thereby applying a braking force to cord 240 and arresting relative movement between cords 240, 242 and double glider device 238.

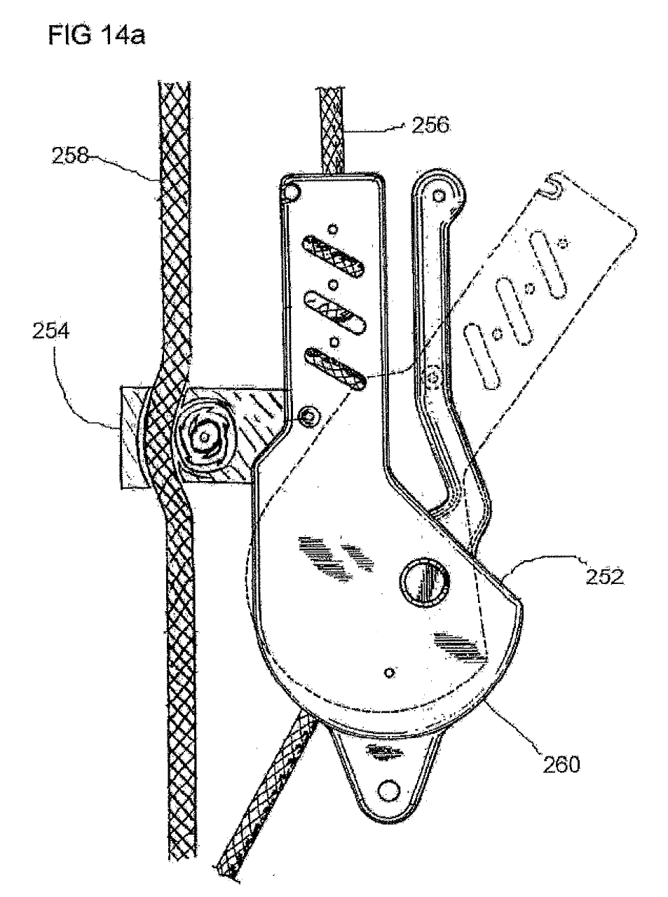

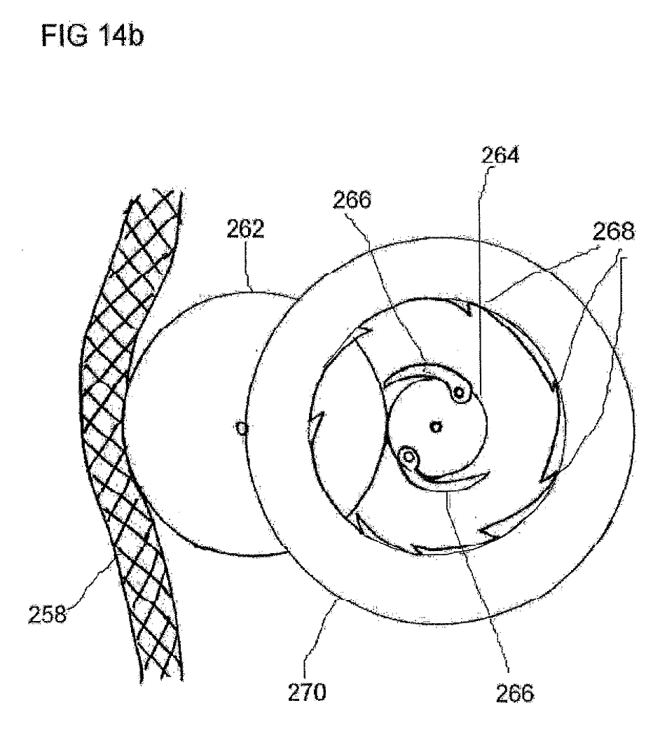

Reference is now made to FIG. 14a, which is a schematic plan view of a gliding system 251 having a glider device 252 and a fail-safe arrangement 254, fail-safe arrangement 254 having its cover removed, gliding system 251 being for use with escape system 150 of FIG. 8a. It will be appreciated by those ordinarily skilled in the art that gliding system 251 can be used with the other embodiments described herein or any other suitable escape system. Glider device 252 is substantially the same as the other glider devices described herein. Gliding system 251 is for simultaneously controlling the descent of a person on a cord 256 and a cord 258. Cord 256 is associated with glider device 252 and cord 258 is associated with fail-safe arrangement 254. If cord 256 should break, fail-safe arrangement 254 at least slows, and preferably stops, the descent of the person descending, as will be explained below. Fail-safe arrangement 254 is mechanically connected to a housing 260 of glider device 252. The term “mechanically connected” is defined herein to include forming fail-safe arrangement 254 and glider device 252 as an integrally formed unit. Fail-safe arrangement 254 is configured for controlling relative movement of cord 258 and fail-safe arrangement 254, such that, when cord 258 moves in relation to fail-safe arrangement 254 with a speed greater than a minimum speed, fail-safe arrangement 254 at least slows, and preferably stops, relative movement between cord 258 and fail-safe arrangement 254.

Reference is now made to FIG. 14b, which is a schematic view illustrating the operation of fail-safe arrangement 254 of FIG. 14a. Fail-safe arrangement 254 works in a similar manner to an inertial seatbelt. Fail-safe arrangement 254 has a pulley 262. Cord 258 partially circumscribes pulley 262. Pulley 262 has gripping teeth (not shown) which prevent cord 258 slipping. Fail-safe arrangement 254 also includes a gear 264, which is mechanically connected to pulley 262 such that, rotation of pulley 262 causes rotation of gear 264. Fail-safe arrangement 254 has two spring-loaded arms 266. Spring-loaded arms 266 are mechanically connected to gear 264 such that the free ends of spring loaded arms 266 move away from the axis of gear 264 as the speed of movement of cord 258 increases. Once the speed of movement of cord 258 exceeds a predetermined speed, spring-loaded arms 266 engage with notches 268 in a housing 270 of fail-safe arrangement 254, thereby stopping rotational movement of pulley 262 and movement of cord 258. Fail-safe arrangement 254 is released by pulling on the loose end of cord 254.

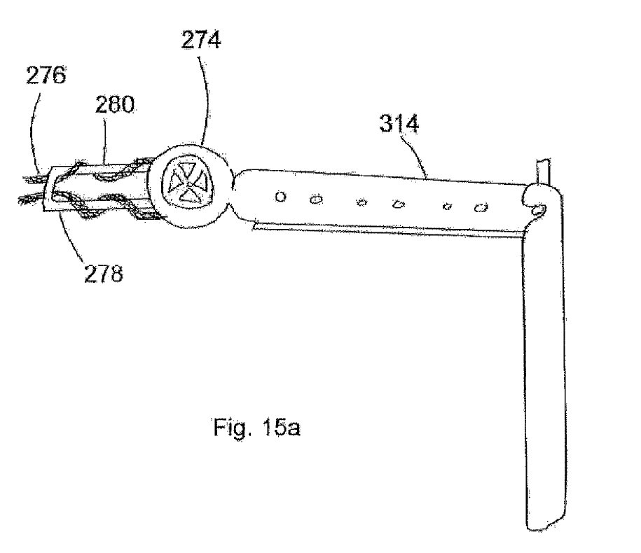

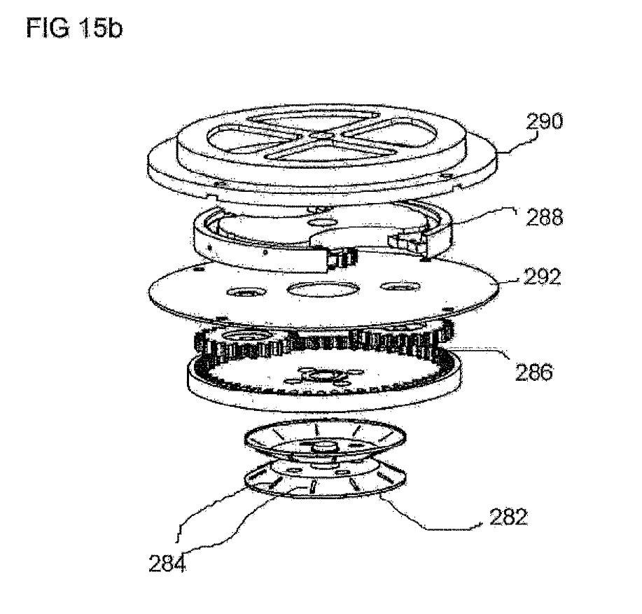

Reference is now made to FIG. 15a, which is front view of an escape system 272 that is constructed and operable in accordance with a fourth alternate embodiment of the invention. Escape system 272 includes a controller arrangement 274 configured to apply a braking force as a function of the speed of movement of a cord 276 having a load thereon. Controller arrangement 274 is configured to limit the speed of cord 276 to a predefined speed, preferably 1 meter per second. Controller arrangement 274 will be described in more detail with reference to FIG. 15b. Escape system 272 also includes an anchoring device 314 for anchoring controller arrangement 274 to a building. Anchoring device 314 is substantially the same as anchoring device 104. Controller arrangement 274 is mechanically connected to anchoring device 104.

Escape system 272 also includes a controller arrangement 278 for applying a braking force to cord 276 according to the magnitude of the load on cord 276. Controller arrangement 278 is a static device, including an elongated element 280 configured for winding cord 276 thereon. The term “static device” is defined herein as, a device that performs its function without using moving parts. The braking force is due to friction between cord 276 and controller arrangement 278 and therefore the braking force is a function of how much cord 276 is wound around elongated element 280. Therefore, when escape system 272 is set up, the magnitude of the load on cord 276 is estimated. Cord 276 is then wound around elongated element 280 in accordance with the estimation of the magnitude of the load. It will be appreciate by those ordinarily skilled in the art that escape system 272 can be used in conjunction with one of the anchoring systems described herein or any other anchoring system.

Reference is now made to FIG. 15b is an exploded view of controller arrangement 274 of escape system 272 of FIG. 15a. Controller arrangement 274 has a pulley 282. Cord 276 (FIG. 15a) partially circumscribes pulley 282. Pulley 282 has a plurality of gripping teeth 284, which prevent cord 276 slipping. Controller arrangement 274 also includes a gear arrangement 286, a mounting plate 292, an expanding brake shoe 288 and a top housing 290. Pulley 282, gear arrangement 286, mounting plate 292, expanding brake shoe 288 and top housing 290 are substantially co-axially disposed. Top housing 290 is fixed to a lower housing (not shown) of controller arrangement 274. Lower housing is typically a circular plate. Pulley 282 is mechanically connected to gear arrangement 286. Gear arrangement 286 transfers and steps-up the rotational motion of pulley 282 to mounting plate 292. Mounting plate 292 is mechanically connected to expanding brake shoe 288. Expanding brake shoe 288 is configured to expand as the rotational speed of mounting plate 292 increases. Expanding brake shoe 288 makes contact with top housing 290, when the rotational speed of mounting plate 292 exceeds a predetermined value. The braking force applied by expanding brake shoe 288 causes pulley 282 to slow down. Therefore, controller arrangement 274 ensures that the speed of movement of cord 276 does not exceed a predetermined speed, typically one meter per second.

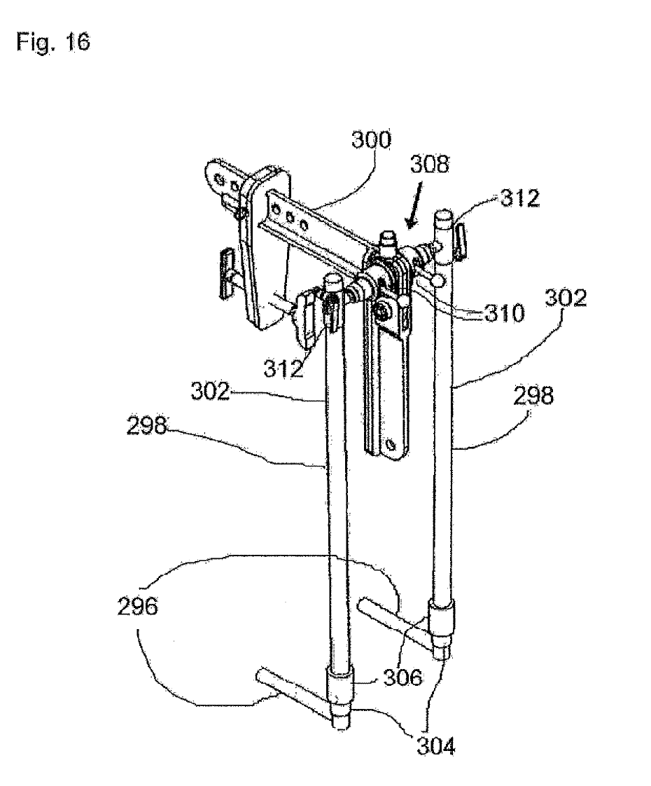

Reference is now made to FIG. 16, which is an isometric view of an escape system 294 that is constructed and operable in accordance with a fifth alternate embodiment of the invention. System 294 is configured for forcing an entry into a target region of a building. System 294 is typically used when access to a lower floor is only accessible by detonating an explosive charge on the outside of the building, for example, adjacent to a sealed window. In such a case, detonating the explosive charge allows access to the otherwise inaccessible target region. System 294 includes two explosive charges 296 configured for forcing the entry into the target region. Explosive charges 296 typically have an elongated form. However, it will be appreciated by those ordinarily skilled in the art that explosive charge 296 may take other forms. System 294 also includes two elongated members 298. One end of each elongated member 298 has one explosive charge 296 mechanically connected thereto, such that the direction of elongation of each explosive charge 296 is perpendicular to the direction of elongation of an associated elongated member 298. Elongated members 298 are extensible. Each elongated member 298 includes an upper pole 302 and a telescopic pole 304. Telescopic pole 304 is mechanically connected to explosive charge 296. The length of elongated members 298 is fixed using a collet 306 disposed on upper pole 302. Collet 306 tightens around telescopic pole 304 to prevent relative movement of upper pole 302 and telescopic pole 304. System 294 also includes an anchoring device 300. Anchoring device 300 is similar to the other anchoring devices described with respect to the other embodiments above. Anchoring device 300 is mechanically connected to each upper pole 302 by a joint arrangement 308. Therefore, anchoring device 300 secures elongated members 298 to the building. Each joint arrangement 308 includes a lockable ball-and-socket joint 310 and a cylindrical clamp 312, giving elongated members 298 several degrees of freedom, as will be described below. Each ball-and-socket joint 310 is mechanically connected to anchoring device 300 and to one cylindrical clamp 312. Bach upper pole 302 is inserted into, and clamped by, one of cylindrical clamps 312. Ball-and-socket joints 310 allow elongated members 298 to be pointed in any direction. Each cylindrical clamp 312 allows an associated elongated member 298 to be rotated around the axis of the elongated member 298. Additionally, cylindrical clamps 312 allows elongated members 298 to be raised up and clamped thereby effectively reducing the length of elongated members 298 protruding from cylindrical clamps 312.

In operation, anchoring device 300 is first clamped to a window of an upper storey of a building. The length of elongated members 298 is then adjusted using collet 306 and/or cylindrical clamp 312. The directions of each elongated members 298 and explosive charges 296 are adjusted using ball-and-socket joint 310 and/or cylindrical clamp 312 so that explosive charges 296 are oriented correctly and positioned adjacent to the target region. Then, explosive charges 296 are detonated. It will be appreciated by those ordinarily skilled in the art that only one of explosive charge 296 needs to be used, depending on the situation.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. An escape system for moving a person on a cord on the exterior of a building, the building having a first surface and a second surface, the first surface and the second surface being substantially perpendicular to each other, the system comprising:
(a) a control device for controlling the movement of the person on the cord; and
(b) an anchoring device for reversibly mechanically attaching said control device to the building, said control device being substantially irreversibly mechanically connected to said anchoring device; said anchoring device having a first elongated element and a second elongated element, said first elongated being mechanically connected to said second elongated element, said first elongated element and said second elongated element being configured such that, said first elongated element at least partially rests against the first surface of the building and said second elongated element at least partially rests against the second surface of the building.

2. The system of claim 1, wherein at least one of said first elongated element and said second elongated element has a anti-slip surface.

3. The system of claim 1, wherein said anchoring device is configured to fold and lock.

4. The system of claim 1, wherein said control device includes:
(a) a housing having an internal volume, an inlet opening and an outlet opening, wherein:
(i) said housing is configured such that, in operation the cord passes through said inlet opening, said internal volume and said outlet opening; and
(ii) said internal volume has a friction arrangement configured for applying a braking force to the cord; and
(b) a control lever mechanically connected to said housing, such that said control lever moves within said housing, wherein said control lever and said housing are configured, such that:
(i) when said control lever is held in a first position, the cord moves relative to said housing, thereby allowing descent of the person; and
(ii) when the position of said control lever is uncontrolled, the cord moves said control lever to a second position thereby applying a braking force to the cord.

5. The system of claim 1, wherein said control device includes:
(a) a pulley configured for at least partially circumscribing the cord thereon; and
(b) a one-way locking arrangement configured for allowing the cord to be moved in one direction only around said pulley.

6. An anchoring system for anchoring a cord to a frame of a door or a window of a building, the frame including a plurality of elongated frame elements, the cord having a load thereon, the anchoring system comprising:
(a) an elongated element having a first end and a second end, said elongated element being extendable; and
(b) two gripping members, one of said gripping members being mechanically connected to said first end, another of said gripping members being mechanically connected to said second end, wherein said elongated element has an extension mechanism for applying an extension force to said elongated element so as to force said gripping members substantially against the frame, said gripping members being configured, such that, said gripping members substantially grip the frame thereby preventing the anchoring system from being pulled out of the frame by the load on the cord.

7. The system of claim 6, wherein at least one of said elongated element and said gripping members have an attachment region for attachment of the cord to said attachment region

8. The system of claim 6, wherein extension mechanism includes a screw thread arrangement for adjusting the length of said elongated element.

9. The system of claim 6, wherein one of said gripping members is configured to extend around one of the elongated frame elements.

10. An anchoring system for anchoring a cord to a frame of a window or a door of a building, the frame including a header element, the building including an wall, the cord having a load thereon, the anchoring system comprising:
(a) a first anchoring device having a first elongated element and a second elongated element, said first anchoring device having an attachment region for attachment of the cord to said attachment region, said first elongated element being mechanically connected to said second elongated element, said first elongated element and said second elongated element being configured, such that:
(i) said first elongated element at least partially rests against the header element of the frame; and
(ii) said second elongated element at least partially rests against the wall of the building; and
(b) a securing pole for securing said first anchoring device adjacent to the header element of the frame, said securing pole including:
(i) an elongated extendable element having a first end and a second end; and
(ii) a first gripping member mechanically connected to said first end; and
(iii) an extension mechanism for applying an extension force on said elongated extendable element so as to secure said first anchoring device between said first gripping member and the header element of the frame, said securing pole being configured, such that, said gripping members grip said first anchoring device, thereby preventing said first anchoring device from being pulled off of the frame by the load on the cord.

11. The system of claim 10, wherein said first anchoring device is configured to fold and lock.

12. The system of claim 10, further comprising a second anchoring device configured such that, at least part of said second anchoring device rests against the internal wall of the building and at least part of said anchoring device rests against the frame, said securing pole including a second gripping member mechanically connected to said second end, said securing pole being configured to secure said second anchoring device between said second gripping member and the frame.

13. A method for controlling the movement of a cord having a load thereon, the method comprising the steps of:
(a) providing a first controller arrangement configured to apply a braking force as a function of the speed of movement of the cord; and
(b) winding the cord around a second controller arrangement according to the magnitude of the load, such that a braking force applied to the cord by the second controller arrangement is a function of an amount of said winding.

14. The method of claim 13, wherein said step of providing is performed by providing a pulley and an expandable braking arrangement for said first controller arrangement, the cord at least partially circumscribing said pulley, said first controller arrangement being configured such that, as the speed of the cord increases, the expandable braking arrangement expands thereby applying a braking force for slowing down said pulley.

15. The method of claim 13, wherein said first controller arrangement is configured to limit the speed of movement of the cord to a first speed.

16. An escape system for lowering a person on a cord, comprising:
(a) a first controller arrangement configured to apply a braking force as a function of the speed of movement of the cord; and
(b) a second controller arrangement configured for manually winding the cord around said second controller arrangement according to the magnitude of the person, such that a braking force applied to the cord by the second controller arrangement is a function of an amount of said winding.

17. The system of claim 16, further comprising an anchoring device for reversibly mechanically attaching said first controller arrangement to the building, said first controller arrangement being mechanically connected to said anchoring device.

18. The system of claim 16, wherein said first controller arrangement includes a pulley and an expandable braking arrangement, said pulley being configured such that, the cord at least partially circumscribes said pulley, said first controller arrangement being configured such that, as the speed of the cord increases, the expandable braking arrangement expands thereby applying a braking force for slowing down said pulley.

19. The system of claim 16, wherein said first controller arrangement is configured to limit the speed of movement of the cord to a first speed.

20. The system of claim 16, wherein said second controller arrangement includes an elongated element for winding the cord around.

21. The system of claim 16, wherein said second controller arrangement is a static device.

22. An escape system for forcing an entry into a target region of a building, the system comprising:
(a) an explosive charge configured for forcing the entry into the target region;
(b) an elongated member having a first end and a second end, said explosive charge being mechanically connected to said first end; and
(c) an anchoring device mechanically connected to said second end, said anchoring device being configured for securing said elongated member to the building, wherein at least one of said anchoring device and said elongated member are configured such that:
(i) said elongated member is extensible; and
(ii) said elongated member rotates, in at least one degree of freedom, with respect to said anchoring device, in order to position said explosive charge adjacent to the target region.
